(19) United States
(12) Patent Application Publication
(10) Pub. No.: US 2022/0283632 A1
(43) Pub. Date: Sep. 8, 2022

(54) IINFORMATION PROCESSING APPARATUS, IMAGE GENERATION METHOD, AND COMPUTER PROGRAM

(71) Applicant: Sony Interactive Entertainment Inc., Tokyo (JP)

(72) Inventors: Yurika MULASE, Tokyo (JP); Yasushi OKUMURA, Tokyo (JP); Kyosuke UCHIDA, Tokyo (JP)

(73) Assignee: Sony Interactive Entertainment Inc., Tokyo (JP)

(21) Appl. No.: 17/825,907

(22) Filed: May 26, 2022

Related U.S. Application Data
(63) Continuation of application No. 16/264,986, filed on Feb. 1, 2019.

(30) Foreign Application Priority Data
Feb. 15, 2018 (JP) 2018-024754

(51) Int. Cl. G06F 3/01; G06F 3/0346; G06F 3/04842; G06T 11/60

(52) U.S. Cl. CPC G06F 3/011; G06F 3/0346; G06F 3/04842; G06T 11/60; A63F 2300/1012; A63F 13/25

(57) ABSTRACT

An information processing apparatus includes a first acquisition unit configured to acquire an image of a virtual space to be displayed on a head-mounted display, a second acquisition unit configured to acquire plural kinds of information relating to the virtual space, an image generation unit configured to generate a displaying image in which the plural components for displaying the plural kinds of information and a controller object corresponding to a controller grasped by a user are disposed in the virtual space, and an output unit configured to cause the head-mounted display to display the displaying image. The image generation unit generates a displaying image in which a component selected by the controller object from the plural components is placed in a selected state, and generates a displaying image in which the display substance in the component in the selected state are updated based on an operation inputted to the controller.

### BACKGROUND

The present technology relates to a data processing technology, and particularly to a technology for processing an image to be displayed on a head-mounted display.

A system has been developed in which a panorama image is displayed on a head-mounted display and a panorama image according to a gaze direction is displayed if a user who has the head-mounted display mounted thereon rotates the head thereof. The sense of immersion in a virtual space can be increased by utilizing the head-mounted display.

### SUMMARY

While the head-mounted display is spreading, it is demanded to provide an innovative viewing experience to a user who has the head-mounted display mounted thereon and views an image of a virtual space (hereinafter referred to also as “virtual reality (VR) image”).

The present technology has been made in view of such a situation as described above, and it is desirable to provide an innovative viewing experience to a user who enjoys a VR image.

According to a mode of the present technology, there is provided an information processing apparatus including a first acquisition unit configured to acquire an image of a virtual space to be displayed on a head-mounted display, a second acquisition unit configured to acquire a plurality of kinds of information relating to the virtual space, an image generation unit configured to generate a displaying image in which a plurality of components for displaying the plurality of kinds of information and a controller object corresponding to a controller that is grasped by a user are disposed in the virtual space, and an output unit configured to cause the head-mounted display to display the displaying image. The image generation unit generates a displaying image in which a component selected by the controller object from among the plurality of components is placed in a selected state, and the image generation unit generates, where a certain component is in a selected state, a displaying image in which the display substance in the component in the selected state are updated based on an operation inputted to the controller.

According to another mode of the present technology, there is provided an image generation method executed by a computer, including acquiring an image of a virtual space to be displayed on a head-mounted display, acquiring a plurality of kinds of information relating to the virtual space, generating a displaying image in which a plurality of components for displaying the plurality of kinds of information and a controller object corresponding to a controller that is grasped by a user are disposed in the virtual space, and displaying the displaying image on the head-mounted display. The generating generates a displaying image in which a component selected by the controller object in the virtual space from among the plurality of components is placed in a selected state, and the generating generates, where a certain component is in the selected state, a displaying image in which the display substance in the component in the selected state is updated based on an operation inputted to the controller.

According to further another mode of the present technology, there is provided a computer program for a computer, including by a first acquisition unit, acquiring an image of a virtual space to be displayed on a head-mounted display, by a second acquisition unit, acquiring a plurality of kinds of information relating to the virtual space, by an image generation unit, generating a displaying image in which a plurality of components for displaying the plurality of kinds of information and a controller object corresponding to a controller that is grasped by a user are disposed in the virtual space, and by an output unit, displaying the displaying image on the head-mounted display. The generating generates a displaying image in which a component selected by the controller object in the virtual space from among the plurality of components is placed in a selected state, and the generating generates, where a certain component is in the selected state, a displaying image in which the display substance in the component in the selected state is updated based on an operation inputted to the controller.

It is to be noted that also results of conversion of arbitrary combinations of the components described above and representations of the present technology between a system, a computer program, a recording medium on which the computer program is recorded readably, a data structure and so forth are effective as modes of the present technology. With the present technology, an innovative viewing experience can be provided to a user who enjoys a VR image.

### BRIEF DESCRIPTION OF THE DRAWINGS

FIG. 1 is an appearance view of a head-mounted display according to an embodiment;

FIG. 2 is a block diagram depicting a functional configuration of the head-mounted display of FIG. 1;

FIG. 3 is a block diagram of an entertainment system according to the embodiment;

FIG. 4 is a view depicting an internal circuit configuration of an information processing apparatus of FIG. 3;

FIG. 5 is a block diagram depicting a functional configuration of the information processing apparatus of FIG. 3; and

FIGS. 6 to 16 are views individually depicting examples of a VR image.

### DETAILED DESCRIPTION OF THE PREFERRED EMBODIMENT

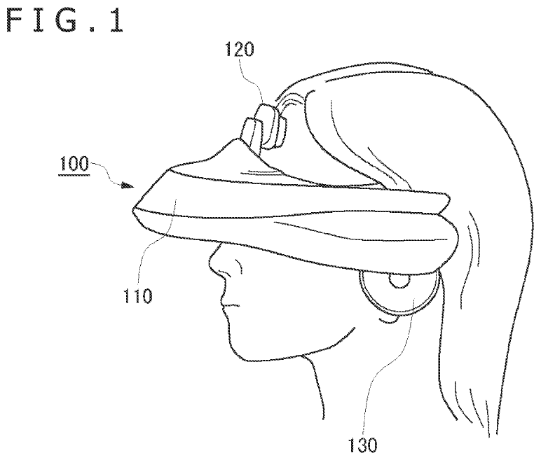

FIG. 1 is an appearance view of a head-mounted display according to an embodiment. A head-mounted display 100 includes a main body unit 110, a forehead contacting portion 120 and a temporal contacting portion 130. The head-mounted display 100 is a display apparatus that is mounted on the head of a user such that the user enjoys a still picture or a dynamic picture displayed on the display and enjoys sound or music outputted from a headphone. There is no limitation to the shape of the head-mounted display 100 and, for example, a cap type or an eyeglass type may be applied.

In the embodiment, posture information including a rotational angle or an inclination of the head of the user who has the head-mounted display 100 mounted thereon and a gaze line of the user are measured by a motion sensor or sensors built in or externally provided on the head-mounted display 100. As a modification, a gaze line may be detected by a motion sensor mounted on the head of the user or by a gazing point detection apparatus used to detect reflection of infrared rays. Alternatively, a marker may be mounted on the head-mounted display or the head of the user such that an image obtained by image pickup of the appearance of the marker is analyzed to estimate a posture and a gaze line of the head-mounted display or the user.

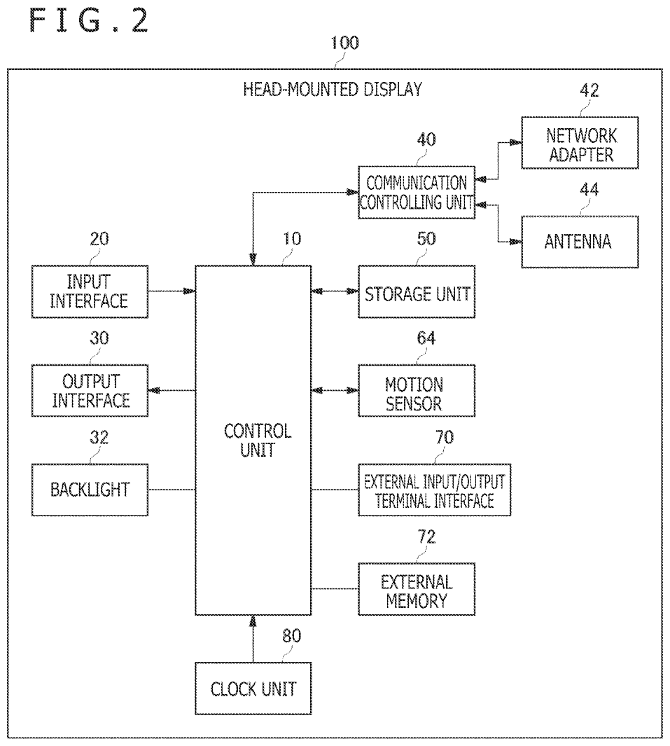

FIG. 2 is a block diagram depicting a functional configuration of the head-mounted display 100 of FIG. 1. A plurality of functional blocks of the block diagram of the present application can be configured in hardware from a circuit block, a memory and some other large-scale integrations (LSIs) and can be implemented in software by execution of a program loaded in the memory by a central processing unit (CPU) or the like. Accordingly, it can be understood by the those skilled in the art that the functional blocks can be implemented in various forms only by hardware, only by software or by a combination of them, and implementation of the functional blocks is not limited to one of the forms.

A control unit 10 is a main processor that processes and outputs a signal such as an image signal or a sensor signal, an instruction or data. An input interface 20 accepts and supplies an operation signal or a setting signal from the user to the control unit 10. An output interface 30 receives an image signal from the control unit 10 and displays an image on a display unit. A backlight 32 supplies backlight to a liquid crystal display unit.

A communication controlling unit 40 transmits data inputted from the control unit 10 to the outside by wired or wireless communication through a network adapter 42 or an antenna 44. The communication controlling unit 40 receives and outputs data from the outside to the control unit 10 by wired or wireless communication through the network adapter 42 or the antenna 44. A storage unit 50 temporarily stores data, a parameter, an operation signal or the like processed by the control unit 10.

A motion sensor 64 detects posture information such as a rotational angle and an inclination of the main body unit 110 of the head-mounted display 100. The motion sensor 64 is implemented by suitably combining a gyro sensor, an acceleration sensor, an angular velocity sensor and so forth. An external input/output terminal interface 70 is an interface for coupling peripheral equipment and, for example, is a universal serial bus (USB) controller. An external memory 72 is an external memory such as a flash memory.

A clock unit 80 sets time information in accordance with a setting signal from the control unit 10 and supplies time data to the control unit 10. The control unit 10 can supply an image or text data to an output interface 30 such that it is displayed on the display unit, and can supply the image or text data to the communication controlling unit 40 so as to be transmitted to the outside.

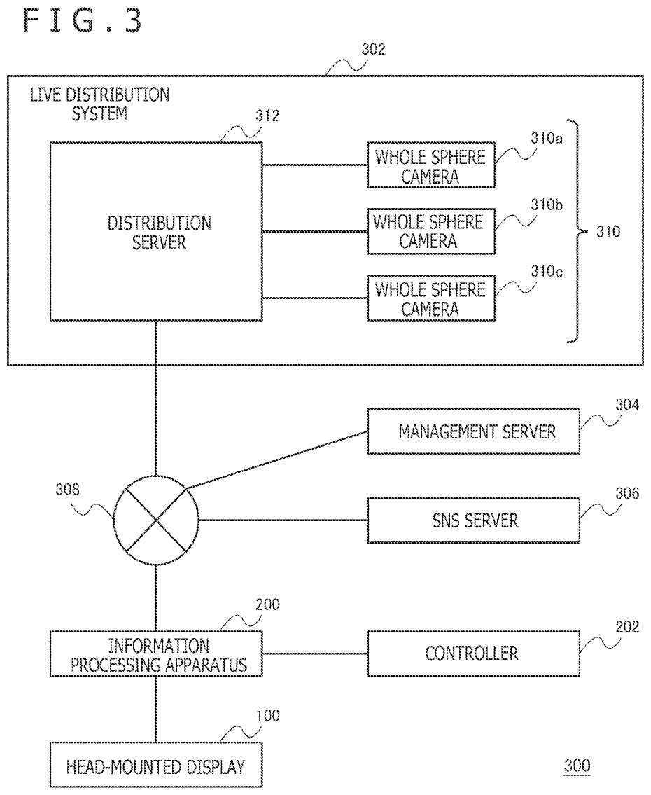

FIG. 3 is a block diagram of an entertainment system according to the embodiment. An entertainment system 300 is an information processing system in which a video of a concert or a conference performed currently is displayed on the head-mounted display 100 the user has mounted thereon.

An information processing apparatus 200 is a stationary type game machine that controls the display substance of the head-mounted display 100. As a modification, the information processing apparatus 200 may be a personal computer (PC), a tablet terminal, a smartphone or a portable type game machine. Further, the information processing apparatus 200 may be integrated with the head-mounted display 100, and, in other words, the function of the information processing apparatus 200 may be incorporated in the head-mounted display 100.

The information processing apparatus 200 is coupled to the head-mounted display 100 and a controller 202 through wireless communication or an interface for coupling peripheral equipment such as a USB apparatus. Further, the information processing apparatus 200 is coupled to a management server 304, a social networking service (SNS) server 306 and a distribution server 312 of a live distribution system 302 through a communication network 308 including a local area network (LAN), a wide area network (WAN), the Internet or the like.

The controller 202 is to be grasped by the user who has the head-mounted display 100 mounted thereon, and accepts an operation of the user for the information processing apparatus 200 and transmits the operation substance to the information processing apparatus 200. Further, the controller 202 includes a motion sensor. The motion sensor detects posture information such as a rotational angle, an inclination or the like of the controller 202. The motion sensor is implemented by suitably combining a gyro sensor, an acceleration sensor, an angular velocity sensor and so forth.

The live distribution system 302 is an information processing system that distributes a video of various events (for example, a concert, a conference or the like) performed currently to a plurality of information processing apparatus 200 of a plurality of users. The live distribution system 302 includes a plurality of whole sphere cameras 310 (for example, a whole sphere camera 310a, another whole sphere camera 310b, and a further whole sphere camera 310c) and the distribution server 312.

The whole sphere cameras 310 are disposed in a place in which an event is performed (for example, a concert place or a conference place indoors or outdoors) and pick up panorama images in all of upward, downward, leftward and rightward directions. Each whole sphere camera 310 can be regarded as an omnidirectional camera or a 360-degree camera. The distribution server 312 transmits data of a panorama image picked up by a whole sphere camera 310 selected from among the plurality of whole sphere cameras 310 by the user to the information processing apparatus 200.

The management server 304 is an information processing apparatus that provides an online service of an account system (for example, a community service for a plurality of users). The management server 304 provides information relating to a friend of the user to the information processing apparatus 200 and relays data to be transferred between a plurality of users (information processing apparatus 200). The SNS server 306 is an information processing apparatus that provides a social networking service. For example, the SNS server 306 provides an image sharing service, a mini blog service and a chat service. The entertainment system 300 may include a plurality of SNS servers 306 of a plurality of SNS traders.

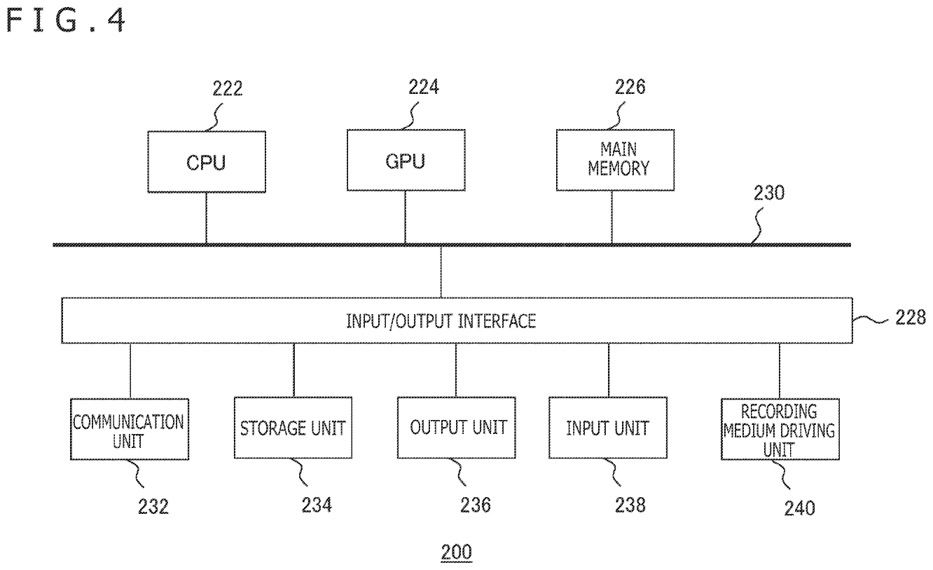

FIG. 4 depicts an internal circuit configuration of the information processing apparatus 200 of FIG. 3. The information processing apparatus 200 includes a CPU 222, a graphics processing unit (GPU) 224 and a main memory 226. The components just mentioned are coupled to each other through a bus 230. Further, an input/output interface 228 is coupled to the bus 230.

To the input/output interface 228, a communication unit 232 configured from a peripheral equipment interface such as a USB interface or an Institute of Electrical and Electronics Engineers (IEEE)1394 interface or a network interface to a wired or wireless LAN, a storage unit 234 such as a hard disk drive or a nonvolatile memory, an output unit 236 that outputs data to a displaying apparatus such as the head-mounted display 100, an input unit 238 that inputs data from the head-mounted display 100 and a recording medium driving unit 240 that drives a removable recording medium such as a magnetic disk, an optical disk or a semiconductor memory are coupled.

The CPU 222 executes an operating system stored in the storage unit 234 to control the entire information processing apparatus 200. Further, the CPU 222 executes various programs that are read out from a removable recording medium and loaded in the main memory 226 or that are downloaded through the communication unit 232. The GPU 224 has a function of a geometry engine and another function of a rendering processor, and performs a drawing process in accordance with a drawing instruction from the CPU 222 and stores the displayed image into a frame buffer not depicted. Then, the displayed image stored in the frame buffer is converted into and outputted as a video signal to the output unit 236. The main memory 226 is configured from a random access memory (RAM) and stores a program or data for the processing.

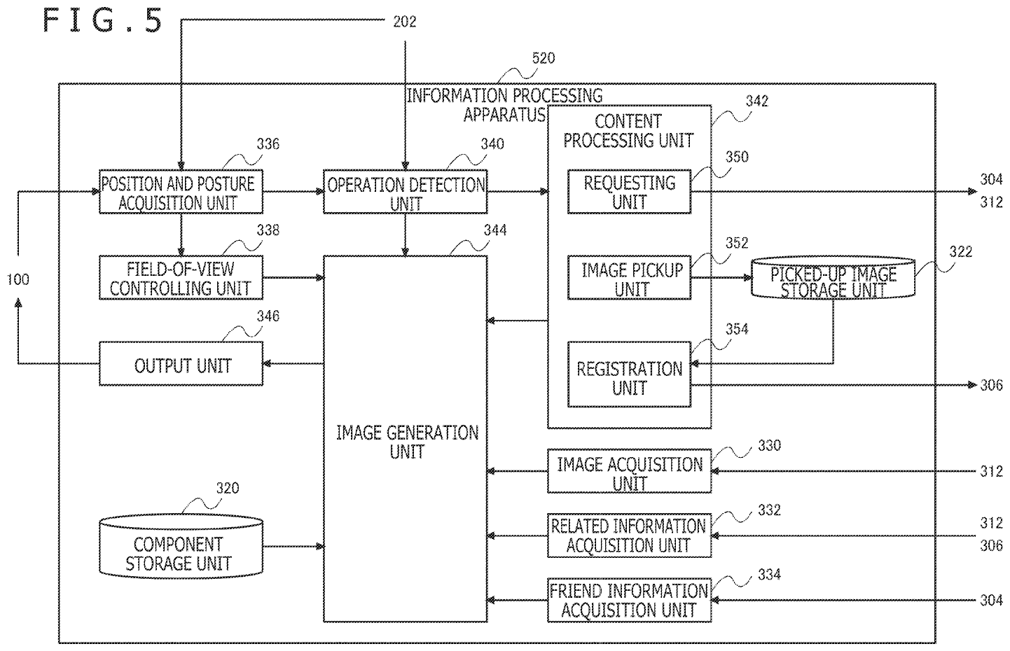

FIG. 5 is a block diagram depicting a functional configuration of the information processing apparatus 200 of FIG. 3. The information processing apparatus 200 includes a component storage unit 320, a picked-up image storage unit 322, an image acquisition unit 330, a related information acquisition unit 332, a friend information acquisition unit 334, a position and posture acquisition unit 336, a field-of-view controlling unit 338, an operation detection unit 340, a content processing unit 342, an image generation unit 344 and an output unit 346. At least part of the components just described may be mounted on the head-mounted display 100 (control unit 10, storage unit 50 and so forth of FIG. 2), or may be incorporated in a server (distribution server 312 or the like) coupled through a network.

At least part of the plurality of functional blocks of FIG. 5 may be mounted in a computer program including modules corresponding to the functional blocks (for example, a live streaming watching application). The computer program may be stored in a recording medium such as a digital versatile disc (DVD) or may be downloaded and stored from the network into the storage unit 234 of the information processing apparatus 200. The CPU 222 and the GPU 224 of the information processing apparatus 200 may read out the computer program into the main memory 226 and execute the computer program to implement functions of the functional blocks.

The component storage unit 320 stores data relating to a shape, the display substance and so forth in regard to a plurality of kinds of components to be displayed in a VR image. The components are graphical user interface (GUI) parts for displaying various information relating to a content (for example, a content of an event, a performer, a speaker or the like) in a virtual space. A component can be considered as a sub window, a panel or a dashboard. The picked-up image storage unit 322 stores image data generated by an image pickup unit 352 hereinafter described.

The image acquisition unit 330 acquires data of a virtual space transmitted from the distribution server 312 and to be displayed on the head-mounted display 100. In particular, the image acquisition unit 330 configures a first acquisition unit that acquires an image of a virtual space. The data of a virtual space includes data of a panorama image picked up by the whole sphere cameras 310. Further, the data of a virtual space includes image pickup target information that is various information relating to an image pickup target such as a content or a schedule of a picked up event, information relating to a performer or a speaker and information indicating an image pickup place.

The related information acquisition unit 332 acquires a plurality of kinds of information (hereinafter referred to sometimes as “related information”) relating to a virtual space to be displayed on the head-mounted display 100 from the distribution server 312 or the SNS server 306. In particular, the related information acquisition unit 332 configures a second acquisition unit. The related information is additional and accompanying information relating to a main content (manner of an event or the like) distributed live and includes information having an instantaneous characteristic. For example, the related information may be (1) image data for a second image, (2) data of a heat map, (3) data relating to a performer or a speaker, (4) a schedule of an event, (5) posted data of a mini blog associated with an event or (6) feed data of a news site, a blog site or the like. In the embodiment, the related information is displayed on the component.

The friend information acquisition unit 334 acquires information relating to one or more friends set in advance by the user (hereinafter referred to sometimes as “friend information”) from the management server 304. The friend information may include at least one of avatar information relating individually to one or more friends, presence or absence of online, activation or deactivation of the head-mounted display 100 and a posture of the head-mounted display 100 (in other words, a gaze direction of the friend).

The position and posture acquisition unit 336 acquires a position and/or a posture of the head-mounted display 100. The position and posture acquisition unit 336 detects a position or a posture of the head of the user who has the head-mounted display 100 mounted thereon at a given rate on the basis of a detection value of the motion sensor 64 of the head-mounted display 100.

The position may be coordinates indicating a position at which the head-mounted display 100 exists in the three-dimensional space in the real world. The posture may be an inclination of the head-mounted display 100 with respect to three axes in the vertical, horizontal and heightwise directions. The position and posture acquisition unit 336 may acquire the position and the posture of the head on the basis of a picked up image by an image pickup apparatus not depicted coupled to the information processing apparatus 200, and may integrate a result of the acquisition with information by the motion sensor.

It is to be noted that the position and the posture of the head-mounted display 100 acquired by the position and posture acquisition unit 336 may be uploaded periodically to the management server 304 by a transmission unit not depicted. The management server 304 may provide information of the position and the posture of the head-mounted display 100 uploaded from the information processing apparatus 200 of a certain user to the information processing apparatus 200 of a friend of the user. Consequently, the position and the posture of the head-mounted display 100 can be shared among the plurality of users (friends).

Further, the position and posture acquisition unit 336 acquires a position and/or a posture of the controller 202. The position and posture acquisition unit 336 detects the position and the posture of the controller 202 at a given rate on the basis of a detection value of the motion sensor built in the controller 202. It is to be noted that the position and posture acquisition unit 336 may acquire the position and the posture of the controller 202 on the basis of a picked up image by an image pickup apparatus not depicted coupled to the information processing apparatus 200, and may integrate a result of the acquisition with information from the motion sensor.

The field-of-view controlling unit 338 controls the field of view of a displayed image on the basis of a gaze line of the user. The field-of-view controlling unit 338 determines a range of the field of view of the user on the basis of the position and/or the posture of the head acquired by the position and posture acquisition unit 336. The field-of-view controlling unit 338 sets a field-of-view plane (screen) with respect to a three-dimensional space of a drawing target.

For example, a background object of a shape of a whole sphere having such a size that includes the component floating in the air and the head of the user may be defined in a global coordinate system similar to that of general computer graphics in a virtual space indicated by a panorama image. Consequently, a sense of depth is provided to a space and a state in which a component floats in the air or another state in which a component is pasted to the background (for example, a wall, a ceiling or the like) of the virtual space can be impressed more. The field-of-view controlling unit 338 may set screen coordinates with respect to the global coordinate system at a given rate on the basis of the posture of the head-mounted display 100.

The direction in which the face of the user faces is turned out from the posture of the head-mounted display 100, namely, from the Euler angle of the head of the user. By at least setting the screen coordinates in an associated relationship with the direction in which the face is directed, the field-of-view controlling unit 338 draws the virtual space on a screen plane in a field of view according to the direction in which the user faces. In this case, the normal vector of the face of the user is estimated as an approximate gaze direction.

It is to be noted that, if an apparatus for detecting a gazing point by reflection of an infrared ray is used, then more detailed gaze line information can be obtained. In the following description, a direction that is estimated or detected irrespective of a derivation method and in which the user watches is totally referred to as direction of “gaze line.” The field-of-view controlling unit 338 may ignore any variation of the detected angle until the variation of the posture of the head of the user exceeds a predetermined value such that an unintentional blur of an image is prevented. Further, in such a case that a zoom operation of a displayed image is accepted, the sensitivity in angle detection of the head may be adjusted on the basis of a zoom magnification.

The operation detection unit 340 detects an operation inputted to the controller 202 by the user on the basis of a signal received from the controller 202. The operation detection unit 340 identifies operation and/or a process instructed by the user as a user operation in response to the operation inputted to the controller 202 and a target of the operation (object in the VR image or the like). The user operation includes, for example, selection of a menu icon, selection of a component, an operation of a component, an operation of a camera and an SNS posting operation. Further, the operation detection unit 340 detects also a position or a posture of the controller 202 detected by the position and posture acquisition unit 336 as the user operation.

The content processing unit 342 executes various data processes in response to the user operation detected by the operation detection unit 340. The content processing unit 342 includes a requesting unit 350, an image pickup unit 352 and a registration unit 354. The requesting unit 350 transmits a request relating to live distribution to the distribution server 312. Further, the requesting unit 350 requests the management server 304 for provision of user information.

The image pickup unit 352 generates an image of an image pickup target region designated by a camera object hereinafter described as a picked up image and stores the picked up image into the picked-up image storage unit 322. The registration unit 354 registers a picked up image designated by the user from among one or more picked up images stored in the picked-up image storage unit 322 into the SNS server 306. Consequently, the registration unit 354 allows browsing of the picked up image by some other users who utilize the SNS.

The image generation unit 344 projects a virtual space indicated by a panorama image acquired by the distribution server 312 on a screen according to a gaze direction of the user determined by the field-of-view controlling unit 338 to generate a displaying image (hereinafter referred to as “VR image”) to be displayed on the head-mounted display 100 at a given rate. Consequently, the image generation unit 344 displays a video of a live-distributed event on the head-mounted display 100 in a mode corresponding to the posture of the user.

The image generation unit 344 may generate a VR image such that it can be viewed stereoscopically in the head-mounted display 100. In particular, the image generation unit 344 may generate, as a VR image, parallax images for the left eye and the right eye to be displayed in regions obtained by dividing a screen of the head-mounted display 100 into a left region and a right region.

The output unit 346 transmits data of a VR image generated by the image generation unit 344 to the head-mounted display 100 at a given rate such that the VR image is displayed on a display unit of the head-mounted display 100.

Operation of the information processing apparatus 200 having the configuration described above is described below.

If the user activates a live streaming viewing application in the information processing apparatus 200, then the information processing apparatus 200 accesses the distribution server 312. The distribution server 312 provides list information of channels that are providing live streaming to the information processing apparatus 200, and the information processing apparatus 200 displays the list information of the channels on the head-mounted display 100. If the user selects a specific channel, then the requesting unit 350 of the information processing apparatus 200 requests the distribution server 312 for distribution of the selected channel video. Here, it is assumed that relay of a game conference is selected.

The distribution server 312 transmits virtual space data including a panorama image of the whole sphere picked up by the whole sphere camera 310 disposed in the venue of the game conference to the information processing apparatus 200 at a given rate. The image acquisition unit 330 of the information processing apparatus 200 acquires the panorama image transmitted from the distribution server 312. The field-of-view controlling unit 338 detects a range of the field of view of the user on the basis of the posture of the head-mounted display 100.

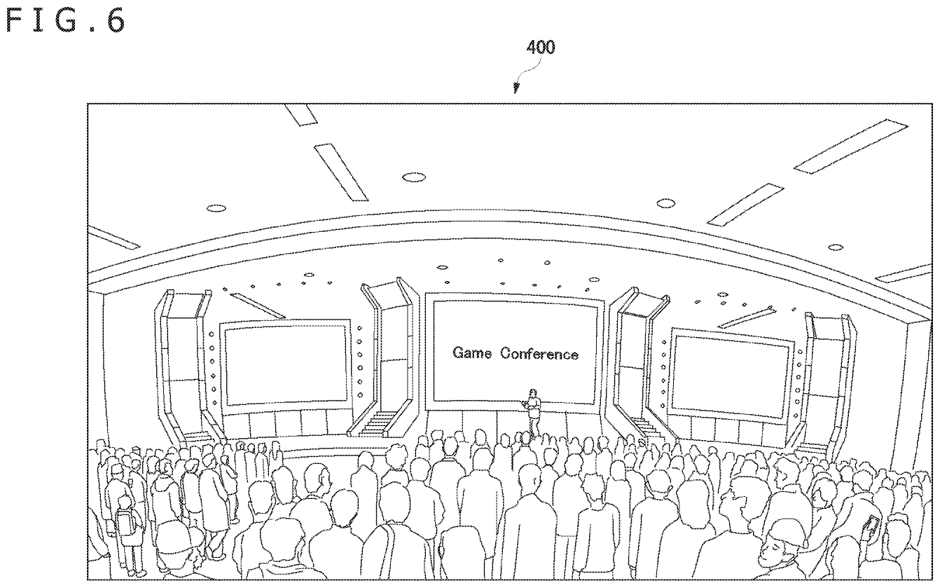

The image generation unit 344 generates a VR image by extracting a range of the field of view of the user from the panorama image. The output unit 346 outputs the VR image to the head-mounted display 100 so as to be displayed. FIGS. 6 to 16 depict an example of the VR image. Transition of the VR image displayed on the head-mounted display 100 is described with reference to FIGS. 6 to 16.

### (1) Operation Relating to Display of Component:

A VR image 400 of FIG. 6 is displayed on the head-mounted display 100 when the user faces the almost front. The position and posture acquisition unit 336 of the information processing apparatus 200 detects a variation of the gaze direction of the user, and the field-of-view controlling unit 338 and the friend information acquisition unit 334 determine a region to be extracted from the panorama image transmitted from the distribution server 312 in response to the variation of the gaze direction of the user. Consequently, the VR image 400 following the variation of the gaze direction of the user is displayed on the head-mounted display 100.

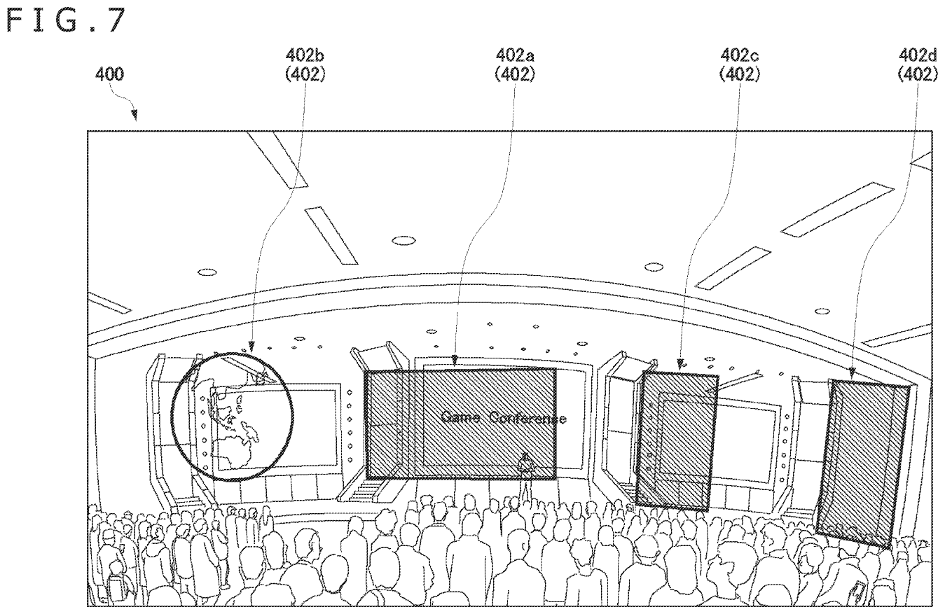

FIG. 7 depicts an example of the VR image 400 in the case where a predetermined operation for instructing display of a component is inputted through the controller 202. In the case where display of a component is instructed, the related information acquisition unit 332 of the information processing apparatus 200 acquires a plurality of kinds of related information relating to the game conference during live distribution from the distribution server 312 or the SNS server 306. The image generation unit 344 of the information processing apparatus 200 generates a VR image 400 in which a plurality of components 402 indicating a plurality of kinds of related information are disposed in an overlapping relationship on the panorama image. It is to be noted that FIG. 7 depicts a state in which the plurality of components 402 are disposed at an initial position. The image generation unit 344 sets a component in a non-selected state to a translucent attribute such that an object on the background can be viewed.

The plurality of components 402 include a component 402a, another component 402b, a further component 402c and a still further component 402d. The component 402a is a component for displaying a second screen. The second screen is a sub window capable of displaying a different content from a main content (content outside the component region) of the VR image 400. The related information acquisition unit 332 acquires image data for the second screen from the distribution server 312. The image generation unit 344 disposes the component 402a in which the image data for the second screen is set to the sub window for the second screen stored in the component storage unit 320 on the VR image 400.

The component 402b is a component for displaying a heat map. The heat map is a graph in which a gray scale of matrix type numerical data is visualized with colors. A globe is drawn in the component 402b of FIG. 7, and an area in which there are many users to whom a video of the game conference is distributed (in other words, an access number to the distribution server 312) is indicated emphatically by a specific color or an animation. The related information acquisition unit 332 acquires matrix data as original data of the heat map from the distribution server 312 or the management server 304. The image generation unit 344 disposes an object for the heat map stored in the component storage unit 320 as the component 402b on the VR image 400 after an appearance is set on the basis of the matrix data.

The component 402c is a component for displaying information relating to a performer or a speaker (hereinafter referred to also as “performer information”). The performer information includes a photograph, a carrier and a profile of a performer or a speaker. The related information acquisition unit 332 acquires the performer information from the distribution server 312. The image generation unit 344 disposes the sub window in which the performer information is set as the component 402c on the VR image 400.

The component 402d is a component for displaying a schedule of an event (here, a game conference). The related information acquisition unit 332 acquires schedule information of an event from the distribution server 312. The image generation unit 344 disposes a sub window in which the schedule information of the event is set as the component 402d on the VR image 400.

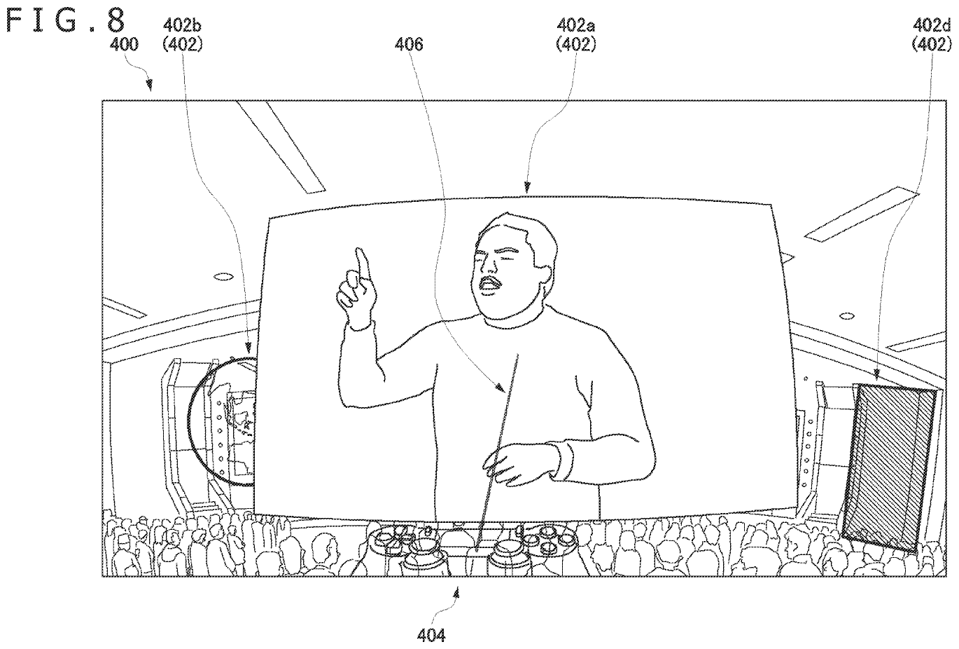

FIG. 8 depicts a VR image 400 in the case where the component 402a (second screen) is selected. In the case where a posture variation of the controller 202 is detected by the position and posture acquisition unit 336, the image generation unit 344 newly generates a VR image 400 on which a controller object 404 and a beam 406 extending from the controller object 404 are further drawn and causes the VR image 400 to be displayed.

The controller object 404 is an object (VR content) in a virtual space corresponding to the controller 202 grasped by the user. The image generation unit 344 synchronizes the posture of the controller 202 and the posture of the controller object 404 with each other and, in other words, varies the posture of the controller object 404 in accordance with the posture variation of the controller 202. The beam 406 is a light beam irradiated vertically from a side face at the depth side (depth side face as viewed from the user) of the controller object 404.

The user would irradiate the beam 406 on a desired component 402 and depress a given button of the controller 202 to select the component 402 as an operation target. Further, in the case where a certain component 402 is placed into a selected state, the user keeps the selected state of the component 402 by continuing to depress the button.

The image generation unit 344 newly generates and displays a VR image 400 in which the component 402 selected by the beam 406 extending from the controller object 404 from among the plurality of components 402 in the VR image 400 is placed in a selected state. In FIG. 8, a state is depicted in which the component 402a (second screen) is selected by the beam 406. The image generation unit 344 sets the component 402 in the selected state to a non-transparent attribute such that an object in the background is not viewed. Further, the image generation unit 344 enlarges the size of the component 402 in the selected state in comparison with the size in the non-selected state.

In the case where the first operation is inputted to the controller 202 when a certain component 402 is placed in a selected state, the image generation unit 344 newly generates a VR image 400 in which the position of the component 402 in the selected state in the virtual space is changed. The first operation here is an operation for changing the position or the posture of the controller 202 in the real world. The image generation unit 344 changes the position or the posture of the component 402 in the selected state in the virtual space in response to a variation of the position or the posture of the controller 202 detected by the position and posture acquisition unit 336. The posture may be indicated by an angle of the component 402 with respect to the gaze direction of the user, or may be indicated by an angle of the component 402 with respect to the vertical direction. For example, in the case where the controller 202 in the real world is moved in the leftward direction, the component 402 in the selected state in the virtual space is moved in the leftward direction.

The user can move a certain component 402 in the virtual space by moving the controller 202 while keeping the state in which the component 402 is selected (while continuing to depress the predetermined button).

In the case where a second operation is inputted to the controller 202 when the certain component 402 is in a selected state, the image generation unit 344 newly generates a VR image 400 in which the component 402 is depicted in a non-selected state and the component 402 is disposed on the background object of the virtual space. The second operation is a same operation as that in the case where the component 402 is placed into a selected state. As described hereinabove, the component 402 in a non-selected state is displayed with a size smaller than that in a selected state and is displayed in a state in which the background can be viewed.

In the case where the second operation is inputted to the controller 202 when the certain component 402 is in a selected state, the image generation unit 344 disposes the component 402 at a position on the background object specified from the posture of the controller object 404. Although, when the certain component 402 is in a selected state, the VR image 400 is placed into a state in which the beam 406 points to the component 402 in the selected state as depicted in FIG. 8, the image generation unit 344 disposes the component 402 at a position at which, in the case where the beam 406 is extended, it reaches the background object (object on the original panorama image).

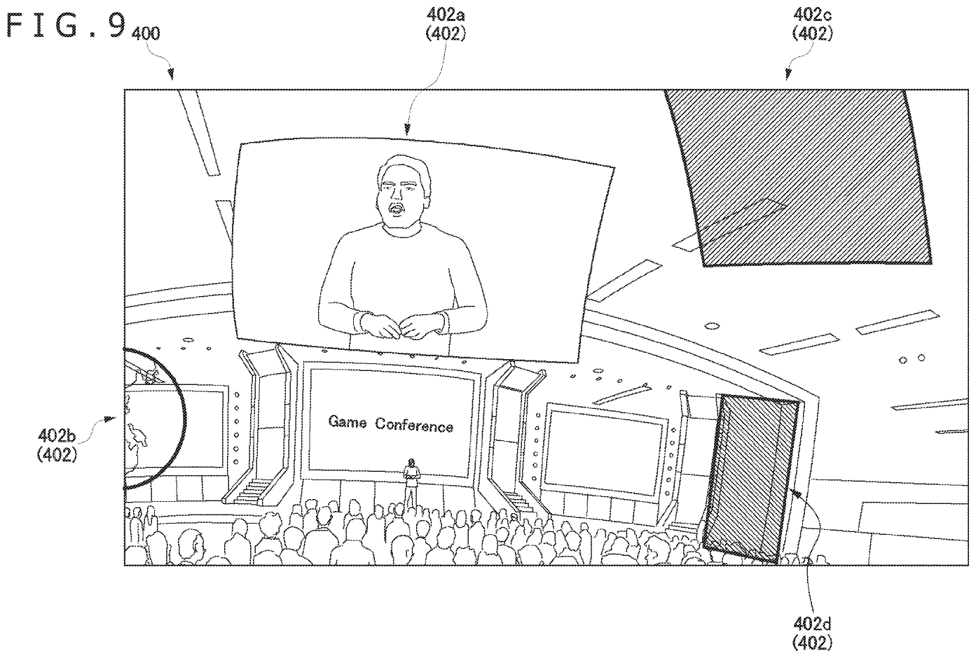

FIG. 9 depicts a state in which, after the position of the component 402a (second screen) and the component 402c (performer information) is changed, they are pasted to a background object (the ceiling of the conference venue or the like) of the virtual space. The image generation unit 344 may map images of the components 402 on a background object such that the components 402 look pasted to the background object. Further, the image generation unit 344 may use the technology of PCT Patent Publication No. WO2017/110632 mentioned hereinabove to generate a VR image 400 in which the components 402 are disposed on a spherical background object centered at the head of the user in the virtual space.

In this manner, the entertainment system 300 of the present embodiment provides various information relating to a main content (for example, a manner of a game conference venue) of live distribution to a user through a component 402. While it is difficult for a user having the head-mounted display 100 mounted thereon to immediately acquire information using a smartphone or the like, where the component 402 presents immediate information, the convenience to the user can be increased.

Further, since a plurality of components 402 can be individually moved to arbitrary positions by the user, such a situation that the components 402 disturb viewing of a main content of live distribution can be prevented. Further, where the components 402 are disposed on a background object, the user is less likely to have a feeling of compression or discomfort.

In the case where a third operation is inputted to the controller 202 when a certain component 402 is in a selected state, the image generation unit 344 newly generates a VR image 400 in which the component 402 in the selected state is turned. The third operation in the embodiment is an operation for a left analog stick of the controller 202.

The image generation unit 344 may store a relationship between a plurality of operation modes for the left analog stick of the controller 202 and a plurality of turning modes of a component 402. In the case where an operation for the left analog stick of the controller 202 is detected, the image generation unit 344 generates a VR image 400 in which the component 402 in the selected state is turned in the mode according to the operation mode and causes the VR image 400 to be displayed. The plurality of turning modes of the component 402 may be pitching, rolling or yawing or a combination of them.

In the case where the second operation is inputted to the component 402 after the component 402 is turned, the image generation unit 344 pastes an image of the component 402 after turned to a background object of the virtual space by texture mapping. By making it possible for a component 402 to be turned by the user in this manner, the degree of freedom of the disposition mode of the component 402 can be increased further.

It is to be noted that a panorama image provided from the distribution server 312 may have added thereto data that indicates a position or a region in which disposition of a component is inhibited (such a region is referred to also as “disposition inhibition position”). In the case where a component 402 whose selected state is cancelled is to be disposed on a background object, the image generation unit 344 may decide whether or not the disposition position designated by the controller object 404 (beam 406) (position at which the component 402 is to be originally disposed) coincides with the disposition inhibition position, in other words, whether or not the designated disposition position is included in a region indicated by the disposition inhibition position.

If the designated disposition position does not coincide with any disposition inhibition position, then the image generation unit 344 disposes the component 402 at the position designated by the controller object 404 (beam 406). On the other hand, in the case where the designated disposition position coincides with a disposition inhibition position, the image generation unit 344 suppresses the component 402 from being disposed at the designated position. For example, the image generation unit 344 may display a VR image 400 including a message indicating that the component 402 is currently not disposed in the designated position while maintaining the selection state of the component 402.

As an alternative, the image generation unit 344 may dispose a component 402 at a position that is a neighboring position with the position designated by the controller object 404 (beam 406) and besides does not correspond to any disposition inhibition position. For example, in the case where a stage center region depicted in FIG. 6 is a disposition inhibition position and the position designated by the controller object 404 (beam 406) corresponds to the stage center region, the image generation unit 344 may dispose the component 402 in a peripheral region of the stage. According to this mode, it can be prevented that the visibility of a main content of live distribution is deteriorated by display of the component.

In the case where a certain component 402 is in a selected state, on the basis of an operation inputted to the controller 202 (for example, an operation of the right analog stick), the image generation unit 344 newly generates a VR image 400 in which the display substance of the component 402 in the selected state is updated. In other words, when a certain component 402 is in a selected state, in the case where a predetermined operation determined as an operation for the component 402 in the selected state in advance is inputted, the image generation unit 344 updates the display substance of the component 402 such that an operation result for the component 402 is indicated.

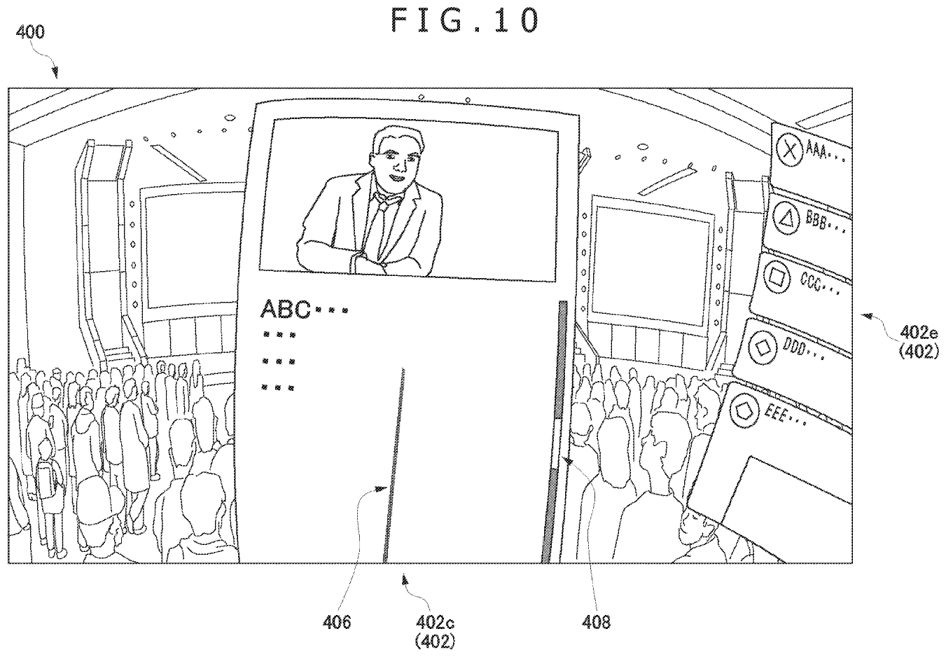

FIG. 10 depicts a state in which the component 402c (performer information) is selected. In the case where the right analog switch of the controller 202 is tilted in a downward direction (in other words, in a rearward direction), the image generation unit 344 scrolls a sentence of the component 402c and a scroll bar 408 in the downward direction. On the other hand, in the case where the right analog stick of the controller 202 is tilted in the upward direction (in other words, in the forward direction), the image generation unit 344 scrolls the sentence of the component 402c and the scroll bar 408 in the upward direction.

It is to be noted that an operation for a component 402 is not limited to an operation for a document. For example, in the case where the component 402a (second screen) is in a selected state, the image generation unit 344 may cause a result of starting of reproduction of a video, stopping of the reproduction, switching to a different video or the like to be displayed on the basis of an operation of the user. On the other hand, in the case where a component 402 for displaying an application of a mini game or the like is in a selected state, the image generation unit 344 may cause an execution result of the application based on an operation of the user (for example, a course and a result of a mini game) to be displayed on the component 402.

In this manner, in the entertainment system 300, the user can execute an operation for various information or an application through a component 402 while viewing a content during live distribution. Consequently, the convenience to the user can be increased further, and an entertainment experiment exceeding mere viewing of a content during live distribution can be provided to the user.

It is to be noted that the component 402e of FIG. 10 displays a comment relating to an event of a live distribution target among contents (tweets or the like) posted to a mini block site. For example, the related information acquisition unit 332 may periodically access the SNS server 306 that provides a mini blog service to acquire a comment associated with an event of a live distribution target (for example, a comment to which a hash tag of the event is applied) from the SNS server 306. The image generation unit 344 may update the display substance of the component 402e every time a new comment is acquired by the related information acquisition unit 332.

In the case where a predetermined operation (here, depression of a predetermined button) is inputted to the controller 202, the image generation unit 344 newly generates a VR image 400 in which one or a plurality of components 402 are collectively placed in a non-displaying state in the virtual space and causes the VR image 400 to be displayed. For example, in the case where a depression operation of the predetermined button is detected while the VR image 400 depicted in FIGS. 7 to 10 is displayed, the image generation unit 344 causes a VR image 400 from which all components 402 are erased (for example, the VR image 400 of FIG. 6) to be displayed. Consequently, in the case where the user wants to concentrate on the main content during live distribution, the user can switchably establish a state in which one or a plurality of components 402 are not displayed collectively by a simple operation.

Further, in the case where, after one or a plurality of components 402 are collectively placed into a non-displayed state, a predetermined operation (here, an operation same as the operation for collectively establishing a non-displaying state) is inputted to the controller 202, the image generation unit 344 newly generates a VR image 400 in which the one or plurality of components 402 are disposed at individual positions same as those immediately before the non-display state is established collectively and causes the VR image 400 to be displayed. By providing a function for collectively displaying and non-displaying one or a plurality of components 402 in this manner, the convenience to a user who enjoys a live distribution content can be increased further.

### (2) Operation Relating to Sharing of Image:

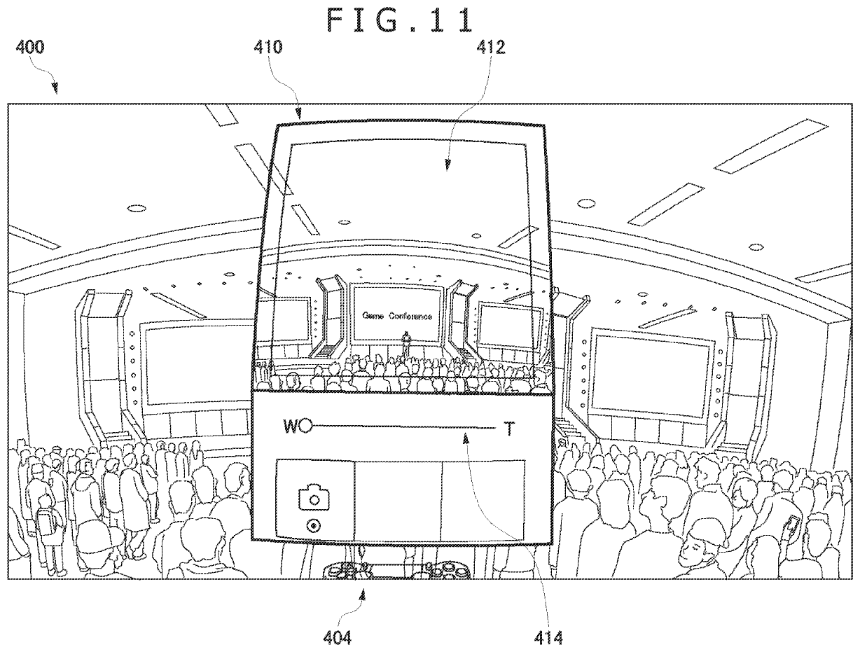

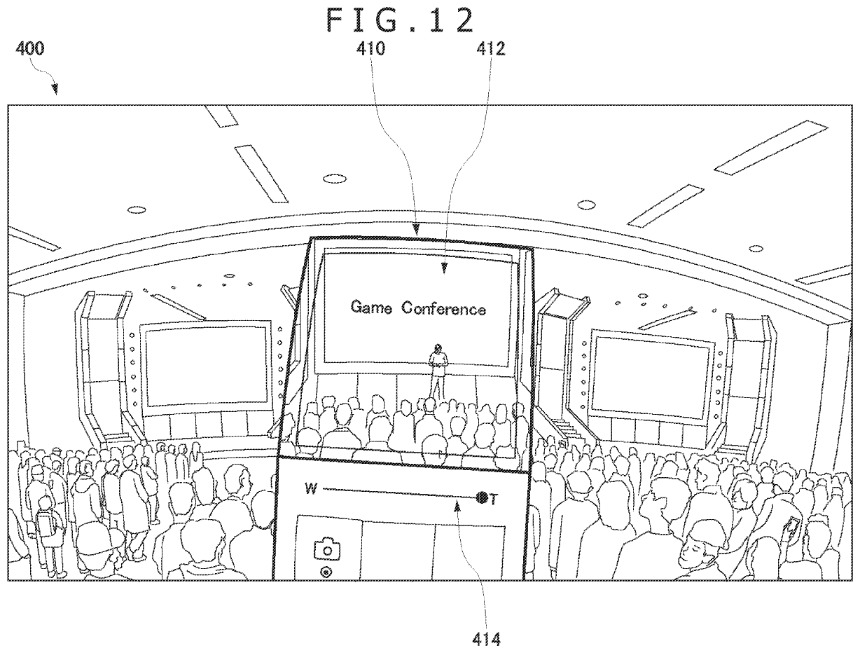

FIGS. 11 and 12 depict a VR image 400 in the case where a predetermined operation that instructs image pickup of a virtual space is inputted through the controller 202. In the case where a predetermined operation that instructs image pickup, as depicted in FIG. 11, the image generation unit 344 of the information processing apparatus 200 generates a VR image 400 in which a camera object 410 that is an object of an appearance that simulates an image pickup apparatus is disposed in an overlapping relationship with a panorama image and causes the VR image 400 to be displayed. The camera object 410 can be regarded as a virtual camera and may have an appearance simulating a screen image of a smartphone in which a camera application is activated. The camera object 410 includes a finder screen 412 indicating a region that becomes an image pickup target in the virtual space and a zoom bar 414 for adjusting the degree of zooming of the image pickup target.

The image generation unit 344 disposes the camera object 410 at a position above and neighboring with the controller object 404. The image generation unit 344 changes the position or the posture of the controller object 404 in the virtual space and newly generates a VR image 400 in which the position or the posture of the camera object 410 is changed in response to a variation of the position or the posture of the controller 202 grasped by the user. In particular, the image generation unit 344 sets a position and a direction of the controller object 404 and the camera object 410 in the virtual space in synchronism with the position, direction and angle of the controller 202 in the real space.

The image generation unit 344 extracts a region of the virtual space coincident in a direction of a virtual optical axis (front face side) of the camera object 410 as an image pickup target region from the panorama image (or the VR image 400) and sets an image of the image pickup target region to the finder screen 412. In FIG. 11, a manner on the stage is cut out and displayed on the finder screen 412. In the case where the position or the posture (direction and angle) of the camera object 410 varies, the image generation unit 344 changes the image pickup target region to be set to the finder screen 412. In particular, the image generation unit 344 determines a region of the virtual space in the axial direction at the position or in the posture after the change as a new image pickup target region and sets an image of the new image pickup target region to the finder screen 412.

In the case where the user is to pick up an image of the image pickup target region indicated by the finder screen 412, the user would depress a predetermined button (for example, a circle button) of the controller 202 as an operation for instructing execution of image pickup. When the input of the image pickup execution operation is detected, the image pickup unit 352 of the information processing apparatus 200 stores the image of the image pickup target region displayed on the finder screen 412 at the point of the operation as a picked up image into the picked-up image storage unit 322.

The zoom bar 414 is a widget for adjusting the degree between “W” (wide angle) and “T” (telescope). In response to an operation inputted to the controller 202 (for example, an operation in the leftward or rightward direction of the right stick), the image generation unit 344 slidably moves the zoom bar 414 and switches the display mode of the picked up image on the finder screen 412 from a wide angle mode to a telescope mode.

For example, in the case where an operation in the rightward direction for the right stick of the controller 202 is inputted, the image generation unit 344 sets an image displayed by enlarging an image pickup target by a digital zoom process to the finder screen 412 as depicted in FIG. 12. For example, the image generation unit 344 may set, to the finder screen 412, an image formed by cutting out a central portion of the image pickup target image before the enlargement and displaying the central portion enlarged by an interpolation process. The image pickup unit 352 stores the image of the image pickup target (for example, an image after a digital zooming process) displayed in an enlarged scale on the finder screen 412 as a picked up image into the picked-up image storage unit 322.

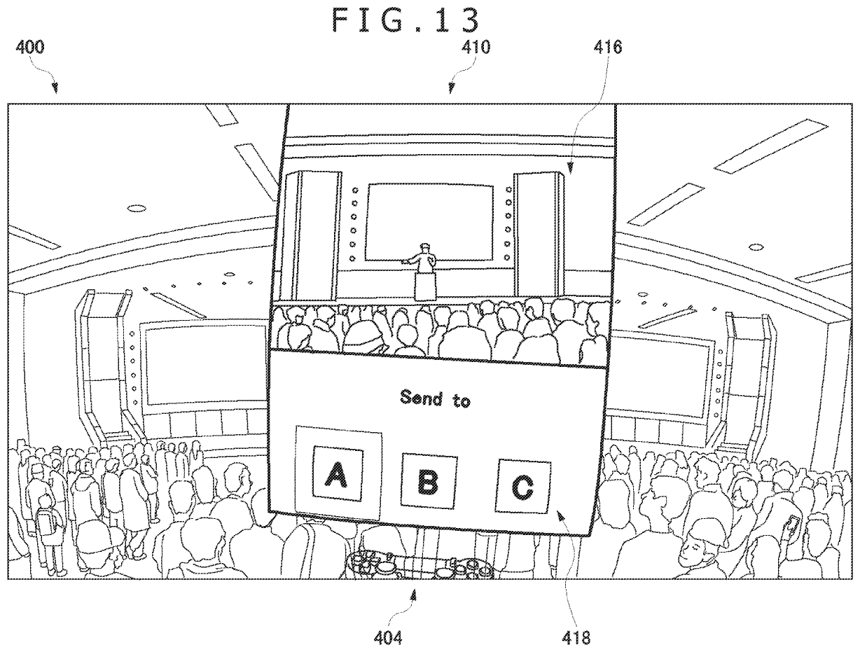

FIG. 13 depicts a VR image 400 in the case where a predetermined operation for instructing sharing of an image (depression of a predetermined button or the like) is inputted through the controller 202. In the case where image sharing is instructed while the camera object 410 is displayed, the image generation unit 344 newly generates a VR image 400 in which the substance of the camera object 410 is switched to an album screen 416 and an operation panel 418 and causes the VR image 400 to be displayed. The image generation unit 344 causes thumbnail images of a plurality of picked up images stored in the picked-up image storage unit 322 to be displayed on the album screen 416. In the case where a particular picked up image is selected on the album screen 416, the image generation unit 344 causes the selected picked up image to be displayed on the album screen 416.

The image generation unit 344 sets icons of a plurality of SNSs (in FIG. 13, three SNSs of “A,” “B” and “C”) into which a picked up image can be registered to the operation panel 418. In the case where an operation for selecting a picked up image of a registration target is inputted by the controller 202 and besides an operation for selecting a particular SNS icon is inputted by the controller 202, the registration unit 354 registers the selected picked up image into the SNS server 306 corresponding to the selected SNS to make it possible for a different user to browse the picked up image. For example, the registration unit 354 may call an application programming interface (API) for image registration (in other words, for article registration) published by the SNS server 306 and transmit the picked up image to the SNS server 306.

The registration unit 354 automatically generates data that explains a content (namely, an image pickup object) of the virtual space (here, the data is called “picked up image explanation information”) on the basis of the image pickup target information provided from the distribution server 312 and acquired by the image acquisition unit 330. The registration unit 354 registers the picked up image explanation information into the SNS server 306 together with the picked up image. The picked up image explanation information (image pickup target information) may include, for example, (1) a name of an event (a game conference or the like) of a live distribution target, (2) a name of a city and a name of a venue in which the event is held and (3) a uniform resource locator (URL) in the case where the information processing apparatus 200 or the like is used to access the event online.

In this manner, according to the entertainment system 300 of the present embodiment, such a VR experience that a smartphone or the like is used in a real event venue to pick up an image of the event can be provided to the user. Further, according to the entertainment system 300, it can be supported to share an image of an event picked up by the user with a different person (friend or the like). Further, although the user having a head-mounted display mounted thereon is difficult to input a character or the like, by automatically adding picked up image explanation information to a picked up image, it becomes easy to allow a different person to understand the substance of the picked up image easily. Further, it is possible to support acquisition of “how nice” in the SNS. Furthermore, the entertainment system 300 can contribute also to notification of an event.

### (3) Operation Relating to Display of Friend:

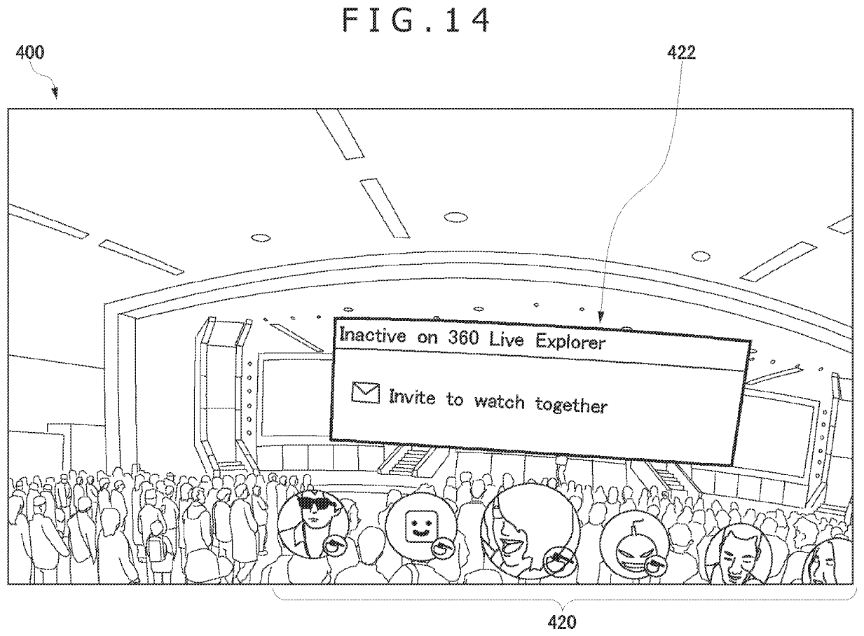

FIG. 14 depicts a VR image 400 that is displayed in the case where a predetermined operation relating to friend information (for example, a selection operation of a friend menu) is inputted through the controller 202. If the friend menu is selected during display of the VR image 400, then the friend information acquisition unit 334 acquires friend information of the user from the management server 304. The image generation unit 344 newly generates a VR image 400 in which avatars 420 of friends of the user indicated by the friend information are lined up and causes the VR image 400 to be displayed.

In the case where an operation for selecting an avatar 420 of a particular friend is inputted, the image generation unit 344 newly generates a VR image 400 that includes an operation panel 422 and causes the VR image 400 to be displayed. The operation panel 422 is the substance indicated by the friend information acquired by the friend information acquisition unit 334 and displays a state at present of the friend indicated by the selected avatar 420. The state at present of the friend may include, for example, whether or not the friend is held in connection to the Internet and/or whether or not the head-mounted display is in operation.

The operation panel 422 further includes an object (link, button or the like) for inviting a friend to an event during live distribution in response to the state of the friend. The object may be, in the case where the state of the friend is a connection state to the Internet and besides the head-mounted display is in operation, an object to which an invitation mail of the substance of guiding a live distribution channel by which a three-dimensional image is distributed is to be transmitted. Further, the object may be, in the case where the state of the friend is a connection state to the Internet and besides the head-mounted display is not activated as yet, an object to which an invitation mail of the substance of guiding a live distribution channel by which a two-dimensional image is distributed is to be transmitted.

In the case where an operation for selecting an object for transmission of an invitation mail is inputted through the controller 202, the requesting unit 350 transmits data for instructing transmission of an invitation mail to the management server 304. The data to be transmitted to the management server 304 may be data for which, for example, the friend indicated by the selected avatar 420 is determined as a destination and besides which designates the substance according to the state of the friend (access designation or the like to be guided by the mail).

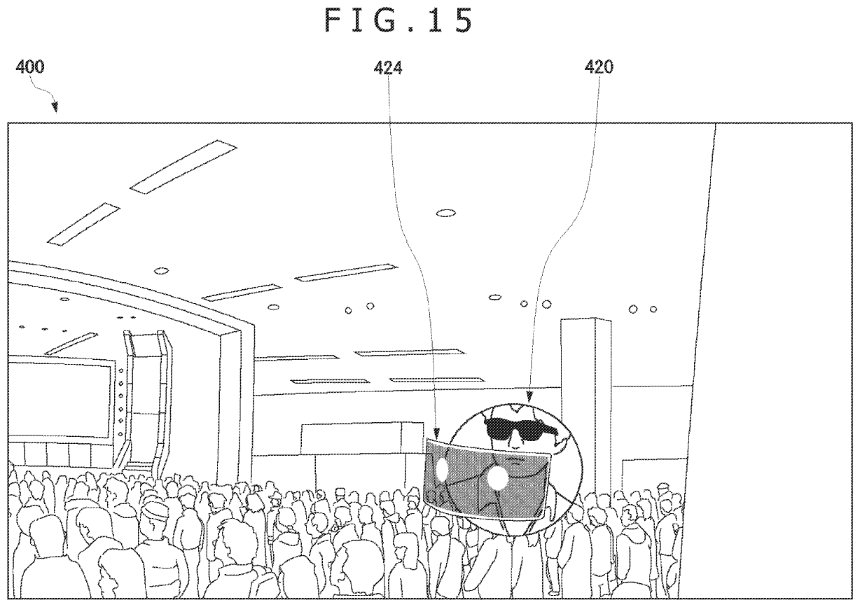

FIG. 15 denotes a VR image 400 displayed in the case where the friend to whom an invitation mail is transmitted establishes a connection to a live distribution channel same as that of the user. The image generation unit 344 causes the avatar 420 of the friend (here, referred to as “participated friend”) to be displayed at a position in the proximity of the user (for example, on a neighboring seat or the like).

In the entertainment system 300, voice chat between users is possible. Voice data of a participated friend inputted to the information processing apparatus 200 of the participated friend is transmitted to the information processing apparatus 200 of the user through the management server 304, and the information processing apparatus 200 causes the voice of the participated friend to be outputted from a speaker, an earphone or the like. While the voice of the participated friend is outputted, the image generation unit 344 increases the brightness of the avatar 420 from an ordinary level or causes the avatar 420 to be displayed blinking. In other words, while the voice of the participated friend is outputted, the image generation unit 344 causes the avatar 420 to be displayed in a mode different from that when voice is not outputted.

The friend information acquisition unit 334 acquires friend information indicative of the posture of the head-mounted display 100 of the participated friend (or the gaze direction of the friend) from the management server 304. The image generation unit 344 adds a posture object 424 indicative of the gaze direction of the participated friend to the avatar 420. The image generation unit 344 sets the direction and the angle of the posture object 424 such that they coincide with the posture of the head-mounted display 100. This makes it easy for the user to grasp the gaze direction of the friend in the event venue, or in other words, to grasp what is viewed by the friend in the event venue and support smooth communication between the user and the friend.

### (4) Operation Relating to Camera Switching:

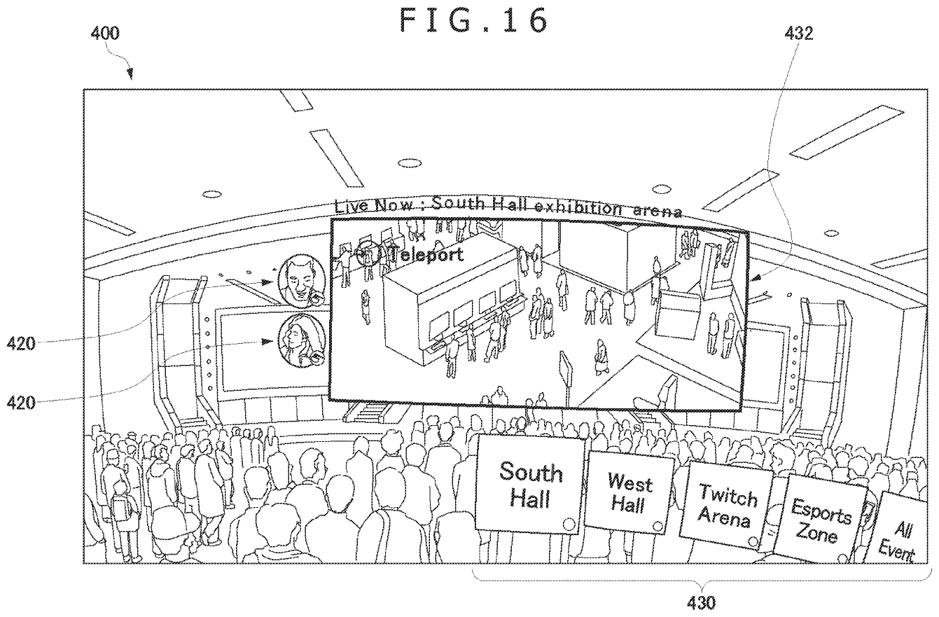

FIG. 16 depicts a VR image 400 displayed in the case where a predetermined operation relating to camera switching (for example, a selection operation of a camera switching menu) is inputted. The image generation unit 344 causes a VR image 400, in which a plurality of venue selection buttons 430 corresponding to a plurality of event venues (south hall, west hall or the like) in each of which whole sphere cameras 310 are installed are disposed, to be displayed. Although a venue is selected here, similar operation is performed also in the case where a plurality of whole sphere cameras 310 are disposed in a same venue and whole sphere cameras 310 that are to pick up a panorama image are to be changed without a change of the venue.

In the case where an operation for focusing a particular venue selection button 430 (for example, a direction inputting operation toward the left or the right) is inputted, the image acquisition unit 330 acquires, from the distribution server 312, a panorama video (or its dynamic image thumbnail image) picked up by the whole sphere cameras 310 disposed in an event venue (also referred to as “temporary selection venue”) indicated by the focused venue selection button 430. The image generation unit 344 causes a relay screen 432 to be displayed and disposes the panorama image (or its dynamic image thumbnail image) picked up by the whole sphere cameras 310 installed in the temporary selection venue on the relay screen 432.

The image acquisition unit 330 further acquires, from the distribution server 312, information of one or more users to whom the panorama video picked up by the whole sphere cameras 310 installed in the temporary selection venue is being distributed (in other words, being viewed). In the case where a friend of the user of the own apparatus exists among the users who are viewing the panorama image, the image generation unit 344 causes the avatar 420 indicative of the friend to be displayed together with the relay screen 432. By this mode, the information processing apparatus 200 can support the user to select a venue or a camera whose live video is viewed.

In the case where a predetermined selection operation (for example, depression of a predetermined button) is inputted in a state in which a particular venue selection button 430 is focused, the requesting unit 350 of the information processing apparatus 200 recognizes the event venue indicated by the focused venue selection button 430 as a final selection venue and transmits, to the distribution server 312, data for requesting live distribution of a panorama image picked up by the whole sphere cameras 310 installed in the final selection venue. Consequently, the main content of live distribution is switched and, for example, a live video of the south hall displayed on the relay screen 432 of FIG. 16 is displayed over the overall VR image 400.

The present technology has been described with reference to the embodiment thereof. The present embodiment is exemplary, and it is recognized by those skilled in the art that various modifications are possible in regard to the combination of components and processes and that also such modifications fall within the scope of the present technology.

Although the foregoing description of the embodiment does not mention, the type of a component 402 and/or the substance displayed in the component 402 may be updated together with the progress of the event, or in other words, they may be updated in accordance with the variation of the main content of live distribution. For example, the distribution server 312 may transmit data for instructing to update the type and/or the display substance of the component 402 (the data is referred to as “component update instruction”) in response to the progress of the event of the live distribution target, for example, in accordance with a schedule determined in advance to the information processing apparatus 200. The component update instruction may include the type and/or the display substance of the component 402 after the update.

The image acquisition unit 330 of the information processing apparatus 200 may receive the component update instruction transmitted from the distribution server 312. The image generation unit 344 of the information processing apparatus 200 may update the type or the substance of at least one component 402 disposed in a VR image in response to the progress of an event (game conference or the like) displayed in the virtual space in accordance with the component update instruction.

The image generation unit 344 of the information processing apparatus 200 may cause a component 402 of a type designated by the component update instruction to be displayed in the VR image 400. Further, the related information acquisition unit 332 may newly acquire related information designated by the component update instruction from the distribution server 312, the SNS server 306 or the like. The image generation unit 344 may cause the related information designated by the component update instruction to be displayed in the component 402 after updated.

According to the configuration described above, for example, in the case where a plurality of commodities are successively introduced in a live relay venue, it is possible to cause information of the introduced commodities to be displayed in a component 402 and switch the display substance of the component 402 every time the commodity to be introduced is switched. Further, it is possible to cause a profile of a speaker on a stage to be displayed in a component 402 and switch the display substance of the component 402 in response to a change of the speaker.

Further, although the description of the embodiment does not mention, in the case where avatars 420 of participated friends are displayed as depicted in FIG. 15 and a friend (hereinafter referred to as FOAF) of a participated friend is viewing same live distribution, the image generation unit 344 may cause the avatar of the FOAF to be displayed separately from the avatar 420 of the participated friend. This makes it possible for the user to have the FOAF introduced from the participated friend and can support increase of friends of the user.

As a particular configuration, the friend information acquisition unit 334 of the information processing apparatus 200 may, in the case where the FOAF is viewing same live distribution, acquire information indicating this from the management server 304. When a notification that the FOAF is viewing same live distribution is received from the management server 304, the image generation unit 344 may cause the avatar of the FOAF to be displayed at a position deeper than that of the avatar 420 of the participated friend as viewed from the user. The image generation unit 344 may display the avatar of the FOAF in such a mode that, although the presence of the avatar is identifiable, the individual of the FOAF is not identifiable. For example, the image generation unit 344 may cause the avatar of the FOAF to be displayed in a blurred form or may cause an object indicative only of a circle having no contents therein to be displayed as the avatar of the FOAF.

Further, while, in the embodiment described above, a VR image based on a live distributed content is displayed on the head-mounted display 100, the technology of the embodiment can be applied to a case in which various VR images are displayed. For example, the VR image to be displayed on the head-mounted display 100 may be, in addition to a panorama still image or a panorama dynamic image of a range of 360 degrees picked up in advance, a VR image based on an artificial panorama image like that of a game space. Further, the technology of the embodiment is useful also in a case in which a VR image based on an execution result of an application by a server connected to the information processing apparatus 200 or a VR image based on an execution result of an application by the information processing apparatus 200 is to be displayed on the head-mounted display 100. In particular, the image acquisition unit 330 of the information processing apparatus 200 may acquire an image of a virtual space as a result of processing of an application by the information processing apparatus 200 or a sever.

Also an arbitrary combination of the embodiment and the modifications described above is useful as embodiments of the present disclosure. A new embodiment produced by such combination exhibits advantageous effects of the embodiment and the modification combined with each other. Also it is recognized by those skilled in the art that functions to be achieved by the constituent features described in the claims are implemented by a simple substance of each constituent feature or by collaboration of such constituent features indicated by the embodiment and the modifications.

The present disclosure contains subject matter related to that disclosed in Japanese Priority Patent Application JP 2018-024754 filed in the Japan Patent Office on Feb. 15, 2018 (H30), the entire content of which is hereby incorporated by reference.

What is claimed is:

1. An information processing apparatus, comprising:
an acquisition unit configured to acquire an image of a virtual space to be displayed on a head-mounted display;
an image generation unit configured to generate a displaying image,
wherein the displaying image comprises an image pickup target region of the virtual space in a field of view of the camera object;
an output unit configured to cause the head-mounted display to display the displaying image; and
an image pickup unit,
wherein the image generation unit generates the displaying image in which the position or orientation of the camera object in the virtual space is changed according to a change in a position or an orientation of a controller held by a user, and generates a display image in which the image pickup target region indicated by the camera object is changed, and
wherein the image pickup unit stores an image of the image pickup target region in response to a predetermined operation by the user.

2. The information processing apparatus according to claim 1,
wherein the image generation unit enlarges and displays an image pickup target in the image input target region in response to an operation input to the controller, and wherein, the image pickup unit stores an image of the imaging target that is enlarged in response to the predetermined operation.

3. The information processing apparatus according to claim 1, further comprising:
a registration unit that allows another user to view the image by registering the image stored by the imaging unit in a predetermined server.

4. The information processing apparatus according to claim 3, wherein,
wherein the registration unit automatically generates data describing the contents of the virtual space, and registers the data together with the image stored by the imaging unit in the server.

5. An image generation method executed by a computer, comprising:
acquiring an image of a virtual space to be displayed on a head-mounted display;
generating a displaying image,
wherein the displaying image comprises an image pickup target region of the virtual space in a field of view of the camera object;
displaying the displaying image on head-mounted display;
changing a position or an orientation of the camera object in the virtual space is response to a change in a position or an orientation of a controller held by a user,
generating a display image in which the image pickup target region indicated by the camera object is changed, and
storing an image of the image pickup target region in response to a predetermined operation by the user.

6. A non-transitory computer readable medium having stored thereon a computer program for a computer, the program comprising:
an acquisition unit configured to acquire an image of a virtual space to be displayed on a head-mounted display;
an image generation unit configured to generate a displaying image,
wherein the displaying image comprises an image pickup target region of the virtual space in a field of view of the camera object;
an output unit configured to cause the head-mounted display to display the displaying image; and
an image pickup unit,
wherein the image generation unit generates the displaying image in which the position or orientation of the camera object in the virtual space is changed according to a change in a position or an orientation of a controller held by a user, and generates a display image in which the image pickup target region indicated by the camera object is changed, and
wherein the image pickup unit stores an image of the image pickup target region in response to a predetermined operation by the user.
